(19) United States
(12) Patent Application Publication
(10) Pub. No.: US 2012/0037095 A1
(43) Pub. Date: Feb. 16, 2012

(54) HOT WATER MIXING VALVE WITH FAILURE DETECTION

(75) Inventor: Samuel Vincent DuPlessis, Louisville, KY (US)

(73) Assignee: General Electric Company

(21) Appl. No.: 12/853,837

(22) Filed: Aug. 10, 2010

(51) Int. Cl. F24H 9/20; G05D 23/185

(52) U.S. Cl. 122/14.3; 236/12.11

(57) ABSTRACT

A mixing valve comprises a housing including first and second inlet passages and a third outlet passage. The first passage is connectable in a high temperature fluid supply line. The second passage is connectable with a low temperature fluid supply. The third passage selectively communicates with the first and second passages. A valve assembly is mounted within the housing. The valve assembly includes a thermostat element and a valve body actuatable by the thermostat element. The thermostat element is contactable thermally by the high temperature fluid passing through the first passage. The valve body is operable under the influence of the thermostat element to regulate flow of low temperature fluid and provide a mix ratio of high temperature fluid and low temperature fluid that results in a mixed fluid having a selected temperature flowing out of the third passage. The mixing valve is adapted to provide feedback to a consumer of a failure condition.

### BACKGROUND

This disclosure relates to mixing valves for reducing or limiting the temperature of outgoing hot water, and in particular, to a hot water mixing valve with failure detection. The exemplary mixing valve with failure detection finds particular application in conjunction with water heaters, and will be described with particular reference thereto. However, it is to be appreciated that the exemplary mixing valve with failure detection is also amenable to other like applications.

Mixing valves are, in general, well known and a typical mixing valve comprises a through channel which is connected in series with a hot water supply line. A cold water inlet communicates with the through channel at an upstream side of a thermostat element. The thermostat element is located in the channel and functions to control the temperature of water passing from the mixing valve. A regulator valve element is located in a fluid passage between the cold water inlet and the through channel. The regulator valve element is controlled by the thermostat element to regulate the quantity of cold water which is admitted into the through channel to mix with the hot water. The thermostat element senses the temperature of the hot-and-cold water mix and controls the regulator valve element to provide a mix ratio that results in a required (pre-determined) outflow temperature. The thermostat element is typically adjustable to provide for the required outflow temperature.

It is known in the art to provide a mixing valve connected between a cold water inlet line and a hot water outlet line remote from or immediately adjacent a water heater. Water heaters are normally set to temperatures above 131° F. (55° C.) to prevent development of bacteria, such as Legionella, in the water supply. The mixing valve is operable to detect the temperature of the water in the hot water line and to introduce cold water into the hot water line when the hot water temperature is too high, thereby reducing the temperature of the hot water delivered.

In some cases, the water heater thermostat is faulty, or set too high. In others, the mixing valve can be malfunctioning. Prior art mixing valves are typically incapable of failure detection. For example, in the known mixing valves which use a wax-filled thermostat element, the regulating valve element will not be actuated and, in a worst case situation, no cold water will be admitted into the hot water stream if the thermostat element fails to function as a result of wax bleeding away from such element. The temperature of the outflowing water will then be approximately equal to that of the inflowing hot water. For at least this reason, and because of the lack of failure detection, regular inspection of the prior art mixing valve is recommended to assure a properly functioning mixing valve.

### BRIEF DESCRIPTION

According to one aspect, a mixing valve comprises a housing including first and second inlet passages and a third, outlet passage. The first passage is connectable in a high temperature fluid supply line. The second passage is connectable with a low temperature fluid supply. The third passage selectively communicates with the first and second passages. A valve assembly is mounted within the housing and includes a thermostat element and a valve body actuatable by the thermostat element. The thermostat element is in thermal contact with the high temperature fluid passing through the first passage. The valve body is operable under the influence of the thermostat element to regulate flow of low temperature fluid and provide a mix ratio of high temperature fluid and low temperature fluid that results in a mixed fluid having a selected temperature flowing out of the third passage. The mixing valve is adapted to provide feedback to a consumer of a failure condition.

According to another aspect, a mixing valve comprises a housing including first and second inlet passages, a third, outlet passage and a mixing chamber. The first passage is connectable to a source of relatively hot water. The second passage is connectable with a source of relatively cold water. The third passage selectively communicates with the first and second passages. The mixing chamber selectively communicates with the first, second and third passages. A valve assembly mixes the hot water with the cold water for providing mixed water at a selected, adjustable temperature for the third passage. The valve assembly is controllable to maintain the mixed water at the selected temperature. The valve assembly provides user feedback of a failure condition by providing one of a limited flow of relatively hot water and a flow of low temperature water through the third passage. The valve assembly prevents a high flow rate of relatively hot water through the third passage during the failure condition.

According to yet another aspect, a water heater comprises a body defining a chamber for holding water to be heated, a heater for heating the water in the chamber to a threshold temperature, and an inlet opening and an outlet opening in communication with the chamber for flowing water therethrough. An inlet line extends through the inlet opening and into the chamber for admitting relatively cold water into the chamber. An outlet line extends through the outlet opening for permitting flow of relatively hot water from the chamber. A mixing valve includes first and second inlet passages and an outlet passage. The first passage is in fluid communication with the inlet line. The second passage is in fluid communication with the outlet line. The outlet passage is in selective fluid communication with the first and second passages. A valve assembly mixes the relatively hot water with the relatively cold water to provide a flow of mixed water at a selected temperature through the third passage. The valve assembly includes a thermostat element and a valve body actuatable by the thermostat element. The valve body includes a first valve member for regulating flow of the relatively hot water and a second valve member for regulating flow of the relatively cold water. The valve body provides user feedback of a failure condition by delivering one of a limited flow of hot water and a flow of low temperature water through the mixing valve. The valve body prevents a high flow rate of the relatively hot water through the mixing valve during the failure condition.

### BRIEF DESCRIPTION OF THE DRAWINGS

FIG. 1 is a schematic of a known water heater.

FIG. 2 is a schematic of a known mixing valve for the water heater of FIG. 1.

FIG. 3 is a schematic of an exemplary new mixing valve for use in the water heater of FIG. 1 according to one aspect of the present disclosure in a no flow condition.

FIG. 4 is a schematic of the exemplary mixing valve of FIG. 3 in a hot water initial state condition.

FIG. 5 is a schematic of the exemplary mixing valve of FIG. 3 in a failure condition.

FIG. 6 is a schematic of the exemplary mixing valve of FIG. 3 in a hot water demand full flow condition.

FIG. 7 is a schematic of an exemplary mixing valve for the water heater of FIG. 1 according to another aspect of the present disclosure, where the exemplary mixing valve is in a hot water initial state condition.

FIG. 8 is a schematic of the exemplary mixing valve of FIG. 7 in a hot water demand full flow condition.

FIG. 9 is a schematic of another exemplary mixing valve for the water heater of FIG. 1 according to yet another aspect of the present disclosure, where the exemplary mixing valve is in a hot water initial state condition.

FIG. 10 is a schematic of the exemplary mixing valve of FIG. 9 in a hot water demand full flow condition.

### DETAILED DESCRIPTION

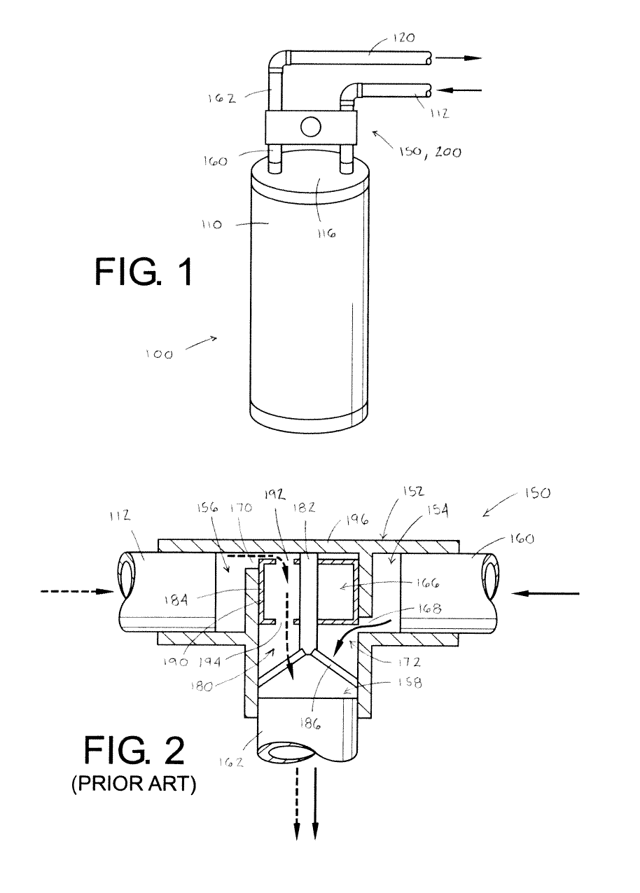

Referring now to the drawings, wherein like numerals refer to like parts throughout the several views, FIG. 1 generally depicts a known water heater 100. The water heater 100 includes a tank or body 110 having an interior chamber or elongated hollow (not shown) for receiving relatively cold water. An inlet line112 extends through an upper portion, particularly a top wall 116, of the tank and into the chamber for admitting relatively cold water into a lower portion of the chamber. An outlet line 120 extends through the upper portion of the tank for permitting flow of relatively hot water from the chamber. A heater (not shown) is operatively associated with the chamber for heating the water within the chamber to a user selected setpoint temperature. The heater preferably comprises one of an electrically driven heating element, a heat pump having a heat exchange system, and/or a gas burner positioned proximate a lower portion of the tank 110. A control panel or user interface (not shown) is provided on the water heater 100 and typically includes a user interface for making various operational selections, such as setting the setpoint temperature of the water heater.

A known mixing valve 150 for the water heater 100 is schematically illustrated in FIG. 2. Typically, the mixing valve 150 is connected between the inlet line 112 and the outlet line 120 remote from or immediately adjacent the water heater 100. The mixing valve 150 is operable to detect the temperature of the relatively hot water flowing through the outlet line 120 and introduce relatively cold water flowing through the inlet line 112 into the outlet line when the water temperature is too high. This reduces the temperature of the relatively hot water being delivered from the water heater 100.

With reference to FIG. 2, the known mixing valve 150 comprises a housing 152 including first and second inlet passages 154, 156 and an outlet passage 158. The first inlet passage 154 is connectable to a first section 160 of the outlet line 120 to receive hot water. The second inlet passage 154 is connectable with the inlet line 112 to receive cold water. The outlet passage 158 is connectable to a second section 162 of the outlet line 120 and is in selective fluid communication with the first and second inlet passages 154, 156 to provide water at a desired temperature. The housing 152 further includes a water mixing chamber 166. The mixing chamber has a relatively hot water inlet 168 in fluid communication with the first inlet passage 154, a relatively cold water inlet 170 in fluid communication with the second inlet passage 156 and a mixed water outlet 172 in fluid communication with the outlet passage 158.

The mixing valve 150 further includes what is generally referred to as a wax motor or a valve assembly 180 moveably mounted within the mixing chamber 166. The valve assembly 180 includes a thermostat element 182, a regulator valve element 184 that is operatively connected to and actuatable by the thermostat element and a biasing member, such as a spring 186. The regulator valve element 184 includes a body 190 having an inlet opening 192 and an outlet opening 194. The inlet opening 192 is positioned adjacent a wall 196 of the housing 152 and is in selective fluid communication with the relatively cold water inlet 170. In a closed position, the body 190 abuts the wall 196 to prevent the flow of relatively cold water through the body 190 and into the mixing chamber. In an open position, the body 190 is spaced from the wall 196 allowing the flow of relatively cold water into the mixing chamber 166. The outlet opening 194 is in fluid communication with the mixed water outlet 172.

The thermostat element 182 extends through the body 190 and has a first end section proximate the housing wall 196 and a second end section operatively coupled to the spring 186. Linear movement of the regulator valve element 184 in response to thermal expansion of the thermostat element 182 in a first direction within the mixing chamber 166 moves the regulator valve element away from the housing wall 196. As the regulator valve element moves in the first direction, the body 190 restricts the flow of relatively hot water through the inlet 168. This allows relatively cold water to flow into the inlet opening 192 through the body 190 and to the outlet opening 194 for mixing with the relatively hot water. Linear movement of the regulator valve element 184 in response to thermal contraction of the thermostat element 182 in a second direction within the mixing chamber 166 moves the regulator valve element towards the housing wall 196. This limits or prevents the flow of relatively cold water through the body 190 for mixing with the relatively hot water flowing through the inlet 168.

The thermostat element 182 functions to control the temperature of the relatively hot water passing from the mixing valve 150. Typically, the thermostat element 182 is of the type which operates by thermal expansion and can be charged with wax or other similar material which has a high coefficient of thermal expansion. The thermostat element 182 is contactable thermally by the relatively hot water passing through the first inlet passage 154 and into the mixing chamber 166 via the inlet 168. The regulator valve element 184 is actuated by the thermostat element 182 to regulate the quantity of relatively cold water which is admitted into the mixing chamber 166 via inlet 170 to mix with the relatively hot water. The thermostat element 182 is responsive to the temperature of the hot-and-cold water mix and contracts/expands which actuates the regulator valve element 184 to provide a mix ratio that results in a required or predetermined outflow water temperature (i.e., the user selected setpoint temperature). The thermostat setpoint is generally controlled by the spring 186 with user adjustment on spring compression. The spring 186 acts to urge the valve body 190 in the upward position of FIG. 2 which serves to restrict or shut-off the cold water inlet.

More particularly, in use, when the thermostat element 182 is exposed to a temperature increase, the wax or other material within the thermostat element is caused to expand. This expansion will act to move the valve body against the spring. The user selected setpoint for output temperature is based on the compression of the spring. The valve body moves with the expansion of the wax and further compresses the spring. As the valve body moves it opens a cold water inlet thus reducing the temperature of the water and thus regulating the outlet water temperature lower. Conversely a temperature decrease will cause the wax to contract reducing the force on the spring and thus the valve body will move to allow less cold water in the system thus regulating the outlet temperature higher. The user selected setpoint temperature, the wax or other material within the thermostat element is caused to expand. This expansion acts against the spring 186 allowing the regulator valve element 184 to move in the first direction within the mixing chamber 166. This movement of the regulator valve element 184 allows the cold water inlet 170 to open more fully and at the same time restricts the hot water inlet 168. Conversely, when the thermostat element is exposed to temperatures less than the user selected setpoint temperature, the wax or other material within the thermostat element 182 will contract. This contraction causes the spring 186 to move the regulator valve element 184 in the second direction within the mixing chamber 166. This movement of the regulator valve element 184 restricts the cold water inlet 170 and at the same time allows the hot water inlet 168 to open more fully. Thus, the known mixing valve 150 automatically and continually maintains the mixed outlet water temperature at the user selected setpoint temperature within the tolerances of the mixing valve.

However, with this known construction, the mixing valve 150 does not include failure detection and fails to provide a low temperature outflow in the event that the valve assembly 180 should malfunction. For example, hard water particulates can build up on an inner surface of the walls of the housing 152, specifically within the mixing chamber 166, which in turn could restrict or prevent movement of the regulator valve element 184 upon expansion of the thermostat element 182. If the regulating valve element 184 is not actuated, no cold water will be admitted into the mixing chamber 166. The temperature of the outflowing water will then be greater than the user selected setpoint temperature for the mixed water. For at least this reason, regular inspection of the prior art mixing valve 150 is recommended to assure a properly functioning system. Corrosive water conditions, unauthorized adjustments or repairs can be detected during inspection and service of the mixing valve 150. The frequency of inspection and cleaning generally depends upon local water conditions.

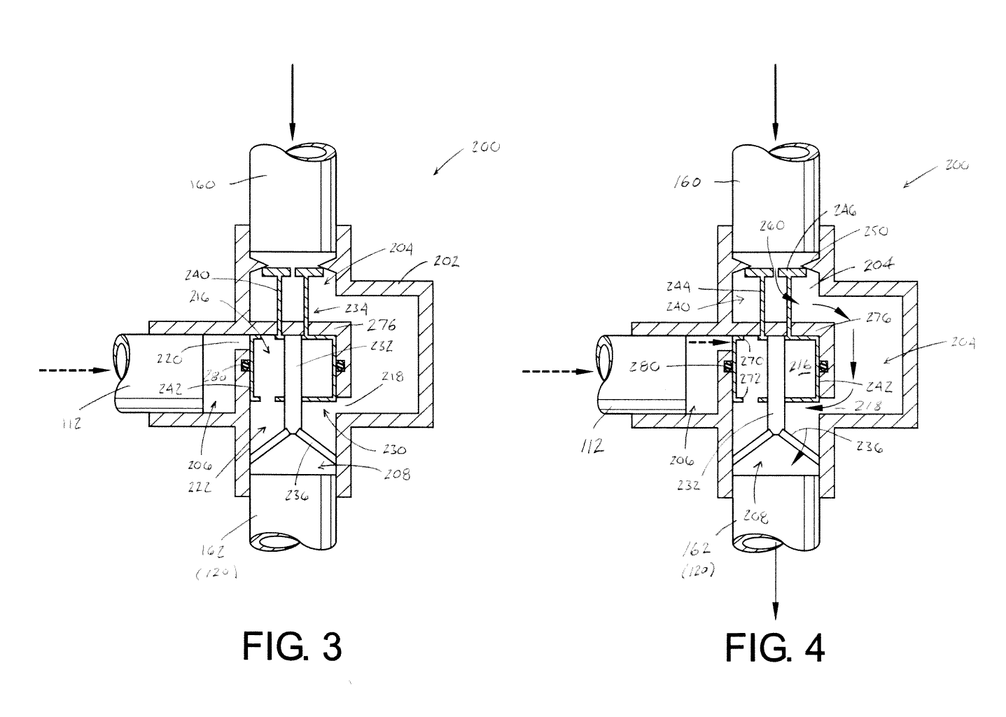

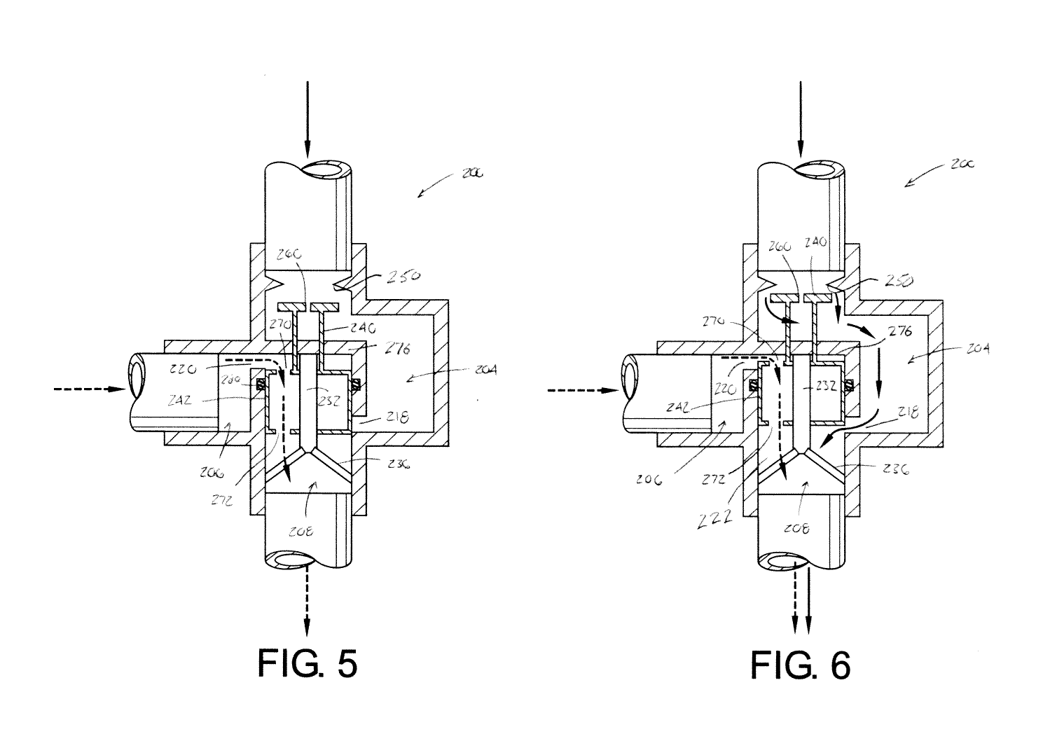

With reference to FIG. 3, a mixing valve 200 according to one aspect of the present disclosure is schematically illustrated. Similar to the known mixing valve 150, the exemplary mixing valve 200 is connected between the relatively cold water inlet line 112 and the relatively hot water outlet line 120 associated with the water heater 100. The mixing valve 200 is operable to detect the temperature of the water flowing through the outlet line 120 and to introduce cold water into the outlet line when the water temperature is too high, thereby reducing the temperature of the relatively hot water delivered. Unlike the known mixing valve 150, the exemplary mixing valve 200 is adapted to provide feedback to a consumer of a failure condition.

The exemplary mixing valve 200 comprises a housing 202 including first and second inlet passages 204, 206 and an outlet passage 208. The first inlet passage 204 is connectable to the first section 160 of the outlet line 120. The second inlet passage 206 is connectable with the inlet line 112. The outlet passage 208 is connectable to the second section 162 of the outlet line 120 and is in selective fluid communication with the first and second inlet passages 204, 206. In the depicted exemplary embodiment, the first inlet passage 204 is oriented generally perpendicular to the second inlet passage 206, although alternative configurations are contemplated. The housing 202 further defines a mixing chamber 216. The mixing chamber has a relatively hot water inlet 218 in fluid communication with the first inlet passage 204, a relatively cold water inlet 220 in fluid communication with the second inlet passage 206 and a mixed water outlet 222 in fluid communication with the outlet passage 208.

The mixing valve 200 includes a wax motor or valve assembly 230 which is at least partially received within the mixing chamber 216. The valve assembly 230 is controllable to maintain the mixed water at the user selected, adjustable setpoint temperature for the water heater 100. As will be discussed in greater detail below, the valve assembly 230 provides user feedback of a failure condition by providing one of a limited flow of relatively hot water and a flow of low temperature water through the third passage 208. The valve assembly prevents a high flow rate of relatively hot water through the third passage during the failure condition.

The valve assembly 230 includes a thermostat element 232, a valve body 234 actuatable by the thermostat element and a biasing member, such as a spring 236. Similar to thermostat element 182, thermostat element 232 operates by thermal expansion and can be charged with wax or other similar material which has a high coefficient of thermal expansion. The valve body 234 is adapted to only allow a fixed flow of hot temperature fluid from the first inlet passage 204 upon initial demand. The thermostat element 232 has an adjustable setpoint temperature which determines the temperature of the mixed fluid flowing out of the third passage. Typically, adjustment of the setpoint temperature is controlled by compressing the spring 236 that biases the valve body 234 upwardly within the mixing chamber 216. The setpoint temperature of the thermostat element typically is lower than the user selected setpoint temperature for the water heater 100. As is well known, a mechanical adjustment permits selection of the desired outlet water temperature within a range of the mixing valve 200. The valve body 234 is configured to deliver the limited flow of relatively hot water to the thermostat element 232 to heat the thermostat element to the setpoint temperature. The valve body 234 is displaceable within the mixing chamber 216 due to its operative engagement with and under the influence of the thermostat element to simultaneously regulate the flow of relatively hot water from the first inlet passage 204 and flow of relatively cold water from the second inlet passage 206 into the mixing chamber upon full demand. The valve body 234 is configured to prevent a high flow rate of hot temperature fluid through the third passage 208 upon failure of the valve assembly 230.

More particularly, and with reference to FIGS. 3 and 4, the valve body 234 includes a first valve member 240 and a second valve member 242 which is operatively associated with or connected to the first valve member 240. According to one aspect, the first and second valve members 240, 242 form a unitary valve body. According to another aspect, the first valve member 240 can be attached to the second valve member 242 in a conventional manner. As a result of this operative connection, the second valve member 242 moves simultaneously with the first valve member 240. This provides a single moving component within the mixing valve 200 for regulating temperature of the mixed water and provides user feedback of the failure condition such as a malfunctioning valve assembly 230.

As shown in FIGS. 3 and 4, the first valve member 240 is located outside the mixing chamber 216 and is associated with the first inlet passage 204 for regulating flow of the relatively hot water flowing through the outlet line 120. The first valve member 240 extends outwardly from the second valve member 242 and includes a first portion 244 connected to the second valve member 242 and a second portion 246 selectively engageable with a valve seat 250 formed in the first inlet passage 204. The first valve portion 244 and the seat 250 are generally configured as high flow rate valves. The first valve member 240 is configured to allow only a limited flow of the high temperature water upon initial user demand from the first inlet passage 204. To this end, the first valve member includes an orifice 260 located in the second portion 246 and dimensioned to allow the limited flow of the relatively hot water upon initial demand from the first inlet passage 204 through the outlet passage 208. The fixed flow orifice 260 is adapted to limit the flow to a set flow rate under varying pressure drops. In the exemplary embodiment, the orifice 260 is preferably and centrally positioned on the second portion 246 and provides for less than about 0.5 gpm, more preferably about 0.25 gpm, of relatively hot water through the first valve member upon initial demand. Ideally, the initial flow rate will be tuned to a minimum value that will provide adequate response time for the thermostatic element to actuate. Alternatively, the first valve portion 244 can be configured to open slightly due to the differential pressure on the supply side line 160 and the outlet 162. Further, the orifice 260 can be configured to be self cleaning as is commonly known.

The second valve member 242 is located at least partially within the mixing chamber and is operatively associated with the thermostat element 232. The second valve member 242 is associated with the second inlet passage 206 for regulating flow of the relatively cold water flowing through the inlet line 112. The second valve member 242 is similar to the regulator valve element 184 described in connection with FIG. 2 and includes an inlet opening 270 and an outlet opening 272. The inlet opening 270 is positioned adjacent a wall 276 of the housing 202 and is in selective fluid communication with the relatively cold water inlet 220. In a closed position (FIG. 4), the second valve member 242 abuts the wall 276 to limit or prevent the flow of relatively cold water through the second valve member and into the mixing chamber 216. In an open position (FIG. 6), the second valve member 242 is spaced from the wall 276 thereby allowing the flow of relatively cold water into the mixing chamber 216. The outlet opening 272 is in fluid communication with the mixed water outlet 222. A seal 280 can be provided to prevent leaking of the relatively cold water into the mixing chamber.

The thermostat element 232 extends through the second valve member 242 and has a first end section proximate or abutting the housing wall 276 and a second end section operatively coupled to the spring 236. The thermostat element 232 is in thermal contact with the high temperature fluid passing through the first inlet passage 204. The valve body 234 is operable under the influence of the thermostat element to regulate flow of the low temperature fluid and provide a mix ratio of high temperature fluid and low temperature fluid that results in a mixed fluid having a selected or predetermined temperature flowing out of the third passage 208.

As shown in FIG. 4, upon initial demand, the first valve member 240 and the second valve member 242 are in a closed position. The orifice 260 of the first valve member 240 provides for a low flow of relatively hot water through the first valve member. This low flow of relatively hot water flows through the first passage 204, the inlet 218 and into the mixing chamber 216. The limited flow of the high temperature water is delivered to the thermostat element 232 for heating the thermostat element to its selected setpoint temperature, which is lower than the temperature of the relatively hot water. As shown in FIG. 6, in a normal operating condition (i.e., full demand), when the thermostat element 232 is exposed to the high temperature water, the wax or other material within the thermostat element is caused to expand. This expansion acts against and overcomes the bias of the spring 236 that urges the second valve member toward a closed position and allows the second valve member 242 to move in a first direction within the mixing chamber 216 away from the housing wall 276. This allows relatively cold water to flow into the inlet opening 270 through the second valve member 242 and to the outlet opening 272 for mixing with the relatively hot water flowing through the inlet 218. As the second valve member 242 moves in the first direction, the first valve member 240 moves away from the valve seat 250 allowing a higher flow of high temperature water through the first inlet passage 204. However, movement of the second valve member 242 to allow the cold water inlet 220 to open more fully simultaneously restricts the flow of the relatively hot water through the inlet 218. Thus, upon reaching the setpoint temperature, the first and second valve members simultaneously move to provide the mixing of the high and low temperature.

Conversely, when the thermostat element 232 is exposed to temperatures less than the user selected setpoint temperature, the wax or other material within the thermostat element 232 will contract. This contraction allows the biasing force of the spring 236 to move the second valve member 242 in a second direction within the mixing chamber 216 towards the housing wall 276. This prevents the flow of relatively cold water through inlet 220 and the second valve member for mixing with the relatively hot water flowing through the inlet 218. This movement of the second valve member restricts the cold water inlet 220 and at the same time allows the hot water inlet 218 to open more fully. Thus, the exemplary mixing valve 200 automatically and continually maintains the mixed outlet water temperature at the user selected setpoint temperature within the tolerances of the mixing valve.

As indicated previously, the exemplary mixing valve 200 is adapted to provide feedback to a consumer of a failure condition of the valve assembly 230. In a failure condition, the second valve member 242 can be retained in one of the fully closed position (FIG. 4) and the fully open position (FIG. 6). The valve could also fail to move in some position between the two positions. The fully open position will provide significant cold water inlet and a reduction of hot water through open 218. This results in a colder water outlet condition and feedback to the user is water below a set temperature at the desired flow rate. A failure in the fully closed position will allow hot water to flow only through orifice opening 260 at a reduced flow rate. Thus, user feedback is one of the limited flow of the high temperature water or a low temperature fluid flowing out of the third passage. Particularly, as shown in FIG. 4, the first valve member 240 is configured to allow only a limited flow of the high temperature water upon initial demand from the first inlet passage. This high temperature water flows through the inlet 218 and the outlet passage 208 into the outlet line 120. If the second valve member 242 is retained in the closed position, for example by a build-up of hard water particulates within the mixing chamber 216, the first valve member 240 will also remain in the closed position. The user will immediately recognize this failure condition by the low flow of relatively hot water through the outlet line 120. Thus, the valve assembly 230 prevents a high flow rate of relatively hot water through the outlet passage 208 during the failure condition. As shown in FIG. 6, the second valve member 242 is retained in the open position. This prevents the flow of relatively hot water through the inlet 218. The user will immediately recognize this failure condition by the flow of relatively cold water through the outlet line 120. Thus, the valve assembly 230 provides user feedback of a failure condition by providing one of a limited flow of relatively hot water and a flow of low temperature water through the outlet line 120 of the water heater 100, conditions which are readily recognizable by the user.

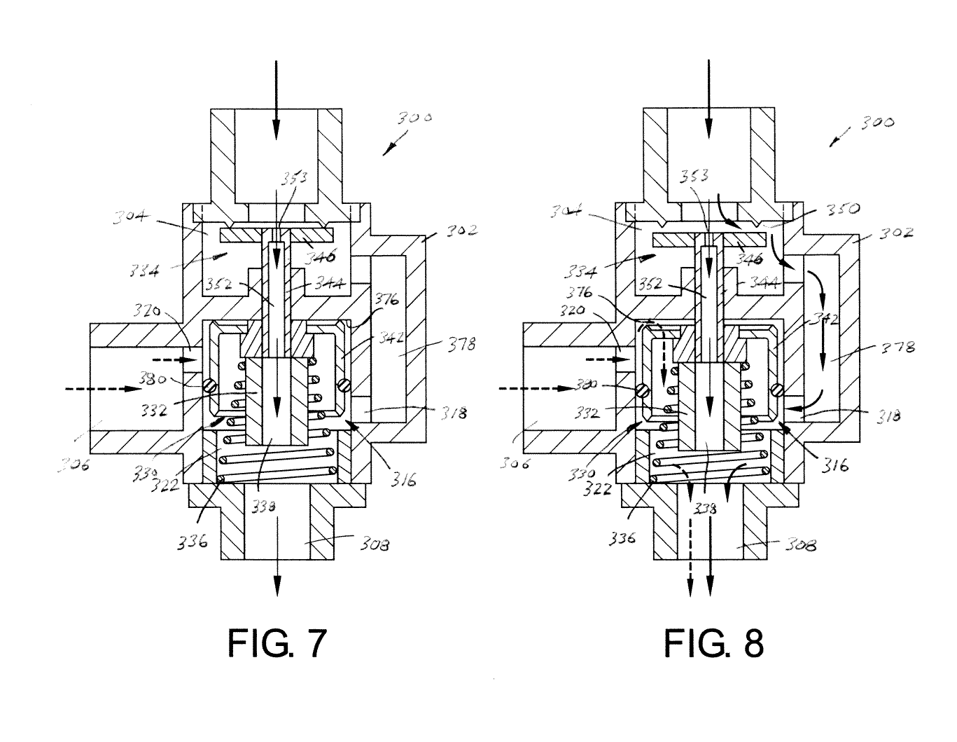

With reference to FIGS. 7 and 8, a mixing valve 300 according to another aspect of the present disclosure is schematically illustrated. Similar to mixing valve 200, mixing valve 300 is adapted to provide feedback to a consumer of a failure condition. The mixing valve 300 comprises a housing 302 including first and second inlet passages 304, 306 and an outlet passage 308. The housing 302 includes a mixing chamber 316 which has a relatively hot water inlet 318 in fluid communication with the first inlet passage 304, a relatively cold water inlet 320 in fluid communication with the second inlet passage 306 and a mixed water outlet 322 in fluid communication with the outlet passage 308.

The mixing valve 300 includes a wax motor or valve assembly 330 which is at least partially received within the mixing chamber 316. The valve assembly 330 includes a thermostat element 332, a valve body 334 actuatable by the thermostat element and a biasing member, such as a spring 336. In this exemplary embodiment, the thermostat element 332 is generally cylindrically shaped and includes a bore 338 extending longitudinally therethrough. The valve body 334 is configured to deliver the limited flow of relatively hot water to the thermostat element 332 to heat the thermostat element to a user selected setpoint temperature and prevent a high flow rate of hot temperature fluid through the third passage 308 upon failure of the valve assembly 330.

The valve body 334 is displaceable within the mixing chamber 316 under the influence of the thermostat element 332 to simultaneously regulate the flow of relatively hot water from the first inlet passage 304 and flow of relatively cold water from the second inlet passage 306 into the mixing chamber upon full demand. More particularly, the valve body 334 includes a first valve member 340 and a second valve member 342 which is operatively associated with or connected to the first valve member. In this manner, the second valve member 342 moves simultaneously with the first valve member 340. The first valve member 340 is configured to allow only a limited flow of the high temperature water upon initial user demand from the first inlet passage 304. The first valve member 340 includes a hollow stem 344 connected to the second valve member 342 and a valve member 346. As shown, the valve member 346 is generally washer-shaped and connected to one end of the stem 344. The valve member 346 is selectively engageable with a valve seat 350 formed in the first inlet passage 304. The stem defines a passage 352 having a narrow inlet orifice 353 in communication with the outlet line 120 and an outlet in communication with the bore 338 of the thermostat element 332. The narrow orifice 353 and passage 352 is dimensioned to allow a limited flow of the relatively hot water upon initial demand from the outlet line 120 through the bore 338 of the thermostat element 332 and through the outlet passage 308.

The second valve member 342 is located at least partially within the mixing chamber 316 and is operatively associated with the thermostat element 332 and with the second inlet passage 306 for regulating flow of the relatively cold water flowing through the inlet line 112. In a closed position (FIG. 7), the second valve member 342 abuts a wall 376 of the housing 302 to limit or prevent the flow of relatively cold water through the second valve member and into the mixing chamber 316. In an open position (FIG. 8), the second valve member 342 is spaced from the wall 376 thereby allowing the flow of relatively cold water into the mixing chamber 316. A seal, such as O-ring 380, can be provided to prevent leaking of the relatively cold water into the mixing chamber.

As shown in FIG. 7, upon initial demand, the first valve member 340 and the second valve member 342 are in a closed position. The narrow orifice 353 communicates with passage 352 to provide for a low flow of relatively hot water through the mixing valve 300. To heat the thermostat element to its selected setpoint temperature, a limited flow of the high temperature water from the passage 352 flows through the bore 338 of the thermostat element 332. As shown in FIG. 8, in a normal operating condition (i.e., full demand), when the thermostat element 332 is exposed to the high temperature water, the wax or other material within the thermostat element is caused to expand. This expansion acts against the spring 336 allowing the second valve member 342 to move within the mixing chamber 316 away from the housing wall 376. This allows relatively cold water to flow into the inlet opening 320 through the second valve member 342 and to the outlet opening 322. In addition, the first valve member 340 moves away from the valve seat 350 thereby allowing a greater flow of relatively hot water to flow through passage 378 (FIGS. 7-8) and through inlet 318 for introduction into the mixing chamber. In this way, the relatively cold water will mix with the relatively hot water flowing through the inlet 318 and the bore 338 of the thermostat element 332.

As indicated previously, the exemplary mixing valve 300 is adapted to provide feedback to a consumer of a failure condition of the valve assembly 330. For example, in a failure condition, the first and second valve members 340, 342 are maintained in the closed position (FIG. 7), wherein user feedback is the limited flow of the high temperature water out of the third passage 308 that is provided through the narrow orifice 353. The user will immediately recognize this failure condition by the low flow of relatively hot water through the outlet line 120. Thus, the valve assembly 330 prevents a high flow rate of relatively hot water through the outlet passage 308 during the failure condition.

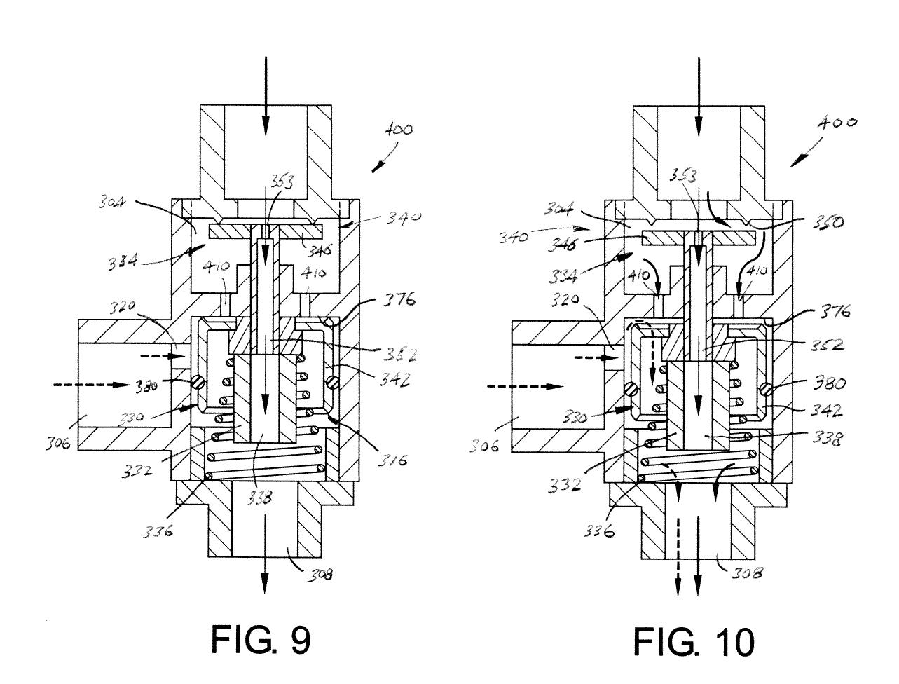

With reference now to FIGS. 9 and 10, a mixing valve 400 according to yet another aspect of the present disclosure is schematically illustrated. Details of mixing valve 400 are generally similar to mixing valve 300 described above, therefore, further description herein of many of the details is deemed unnecessary. To further facilitate the heating of thermostat element 332, the wall 376 includes at least one opening or bore 410 to allow another limited flow of the high temperature water from the inlet passage 304 once the valve 346 has opened. In the depicted embodiment, the wall 376 includes a configuration of openings 410. As shown in FIG. 9, upon initial demand, the first valve member 340 and the second valve member 342 are in a closed position. The passage 352 directs a low flow of relatively hot water through the thermostat element 332 when the first valve member 340 is open or closed. As shown in FIG. 10, in a normal operating condition (i.e., full demand), when the thermostat element 332 is exposed to the high temperature water, the wax or other material within the thermostat element is caused to expand. This expansion acts against the spring 336 causing the first and second valve members to move downwardly a distance determined by thermostatic element 332. More particularly, the second valve member 342 moves within the mixing chamber 316 away from the housing wall 376, allowing relatively cold water to flow into the inlet opening 320 through the second valve member 342, and the first valve member 340 moves away from the valve seat 350 thereby allowing a greater flow of relatively hot water to flow through passage 378 and through inlet openings 410 for introduction into the mixing chamber. In this way, the relatively cold water will mix with the relatively hot water flowing through the inlet openings 410 and the bore 338 of the thermostat element 332

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A mixing valve comprising:
a housing including first and second inlet passages and a third outlet passage, the first passage being connectable in a high temperature fluid supply line, the second passage being connectable with a low temperature fluid supply and the third passage selectively communicating with the first and second passages; and
a valve assembly mounted within the housing, the valve assembly including a thermostat element and a valve body actuatable by the thermostat element, thermostat element contactable thermally by the high temperature fluid passing through the first passage, the valve body being operable under the influence of the thermostat element to regulate flow of low temperature fluid and provide a mix ratio of high temperature fluid and low temperature fluid that results in a mixed fluid having a selected temperature flowing out of the third passage,
wherein the mixing valve is adapted to provide feedback to a consumer of a failure condition.

2. The mixing valve of claim 1, wherein the valve body includes a first valve member associated with the first passage for regulating flow of high temperature fluid and a second valve member associated with the second passage for regulating flow of low temperature fluid,
wherein the thermostat element is at least partially located within a mixing chamber defined by the housing and is operatively associated with the second valve member and includes a setpoint temperature which determines the temperature of the mixed fluid flowing out of the third passage.

3. The mixing valve of claim 2, wherein the second valve member moves simultaneously with the first valve member.

4. The mixing valve of claim 3, wherein the second valve member is connected to the first valve member.

5. The mixing valve of claim 3, wherein the first and second valve members form a unitary valve body.

6. The mixing valve of claim 2, wherein the first valve member is configured to allow only a limited flow of the high temperature fluid upon initial demand from the first passage, wherein the limited flow of the high temperature fluid is delivered to the thermostat element for heating the thermostat element to a selected setpoint temperature, wherein in a normal operating condition, upon reaching the setpoint temperature, the first and second valve members move to provide the mixing of the high and low temperature fluids.

7. The mixing valve of claim 6, wherein the first valve member includes an orifice for limiting flow of high temperature fluid to a set flow rate under varying pressure drops.

8. The mixing valve of claim 7, wherein the first valve member includes a conduit and the thermostat element includes a longitudinally extending bore, the conduit being in communication with the bore, the conduit directing a limited flow of the high temperature fluid from the first passage through the bore upon initial demand.

9. The mixing valve of claim 7, wherein a housing wall that at least partially defines the mixing chamber includes at least one bore, the at least one bore being in communication with the orifice, the at least one bore directing a limited flow of the high temperature fluid from the first passage into the mixing chamber upon initial demand.

10. The mixing valve of claim 6, wherein in a failure condition the second valve member is generally retained in one of a closed position and an open position, wherein user feedback is one of the limited flow of the high temperature fluid and a low temperature fluid flowing from a third passage.

11. The mixing valve of claim 6, wherein in a failure condition the second valve member is generally retained in a fully open position, wherein user feedback is the flow of cold temperature fluid.

12. The mixing valve of claim 11, the housing defining a mixing chamber for at least partially receiving the valve body, the mixing chamber being in communication with the first, second and third passages, the valve body only allowing a fixed flow of hot temperature fluid from the first passage upon initial demand, the valve body being displaceable within the mixing chamber to simultaneously regulate flow of hot temperature fluid from the first passage and flow of low temperature fluid from the second passage into the mixing chamber upon full demand, the valve body preventing a high flow rate of hot temperature fluid through the third passage upon failure of the valve assembly.

13. The mixing valve of claim 1, wherein the valve body includes a single moving component which provides the mixing of the high temperature fluid and low temperature fluid and the user feedback of a malfunctioning valve assembly.

14. A mixing valve comprising:
a housing including first and second inlet passages, a third outlet passage and a mixing chamber, the first passage being connectable to a source of relatively hot water, the second passage being connectable with a source of relatively cold water, the third passage selectively communicating with the first and second passages, the mixing chamber selectively communicating with the first, second and third passages; and
a valve assembly for mixing the hot water with the cold water for providing mixed water at a selected, adjustable temperature for the third passage, the valve assembly being controllable to maintain the mixed water at the selected temperature, the valve assembly providing user feedback of a failure condition by providing one of a limited flow of relatively hot water or a flow of low temperature water through the third passage, the valve assembly preventing a high flow rate of relatively hot water through the third passage during the failure condition.

15. The mixing valve of claim 14, wherein the valve assembly includes a valve body and a thermostat element for operating the valve body, the thermostat element having a setpoint temperature, the valve body configured to deliver the limited flow of relatively hot water to the thermostat element to heat the thermostat element to the setpoint temperature, the valve body being displaceable under the influence of the thermostat element to mix the relatively hot and cold water.

16. The mixing valve of claim 14, wherein the valve body includes a first valve member located outside the mixing chamber and associated with the first passage for regulating flow of relatively hot water, and a second valve member located within the mixing chamber and associated with the second passage for regulating flow of relatively cold water.

17. The mixing valve of claim 16, wherein the second valve member moves simultaneously with the first valve member thereby providing a single moving component for regulating temperature of the mixed water and providing user feedback of the failure condition.

18. The mixing valve of claim 16, wherein the first valve member includes an orifice dimensioned to allow the limited flow of the relatively hot water upon initial demand from the first passage, the orifice limiting flow of hot water during initial demand to a set flow rate under varying pressure drops.

19. The mixing valve of claim 18, wherein the orifice provides for about 0.25 gpm of hot water through the first valve member upon initial demand.

20. A water heater comprising:
a body defining a chamber for holding water to be heated;
a heater for heating the water in the chamber to a threshold temperature;
an inlet opening and an outlet opening in communication with the chamber for flowing water therethrough;
an inlet line extending through the inlet opening and into the chamber for admitting relatively cold water into the chamber;
an outlet line extending through the outlet opening for permitting flow of relatively hot water from the chamber; and
a mixing valve including:
first and second inlet passages, an outlet passage, the first passage being in fluid communication with the inlet line, the second passage being in fluid communication with the outlet line, and the outlet passage being in selective fluid communication with the first and second passages, and
a valve assembly for mixing the relatively hot water with the relatively cold water to provide a flow of mixed water at a selected temperature through the third passage, the valve assembly including a thermostat element and a valve body actuatable by the thermostat element, the valve body including a first valve member for regulating flow of the relatively hot water and a second valve member for regulating flow of the relatively cold water, the valve body providing user feedback of a failure condition by delivering one of a limited flow of hot water or a flow of low temperature water through the mixing valve, the valve body preventing a high flow rate of the relatively hot water through the mixing valve during the failure condition.

21. The water heater of claim 20, wherein the first valve member includes an orifice dimensioned to allow the limited flow of the relatively hot water upon initial demand from the first passage, the orifice limiting flow of hot water during initial demand to a set flow rate under varying pressure drops.

22. The water heater of claim 21, wherein the first valve member includes a conduit and the thermostat element includes a longitudinally extending bore, the conduit being in communication with the bore, the conduit directing a limited flow of the high temperature fluid from the first passage through the bore upon initial demand.

23. A mixing valve comprising:
a housing including first and second inlet passages and a third outlet passage, the first passage being connectable in a high temperature fluid supply line, the second passage being connectable with a low temperature fluid supply and the third passage selectively communicating with the first and second passages; and
a valve assembly mounted within the housing, the valve assembly including a thermostat element and a valve body actuatable by the thermostat element, the thermostat element contactable thermally by the high temperature fluid passing through the first passage, the valve body being operable under the influence of the thermostat element to regulate flow of low temperature fluid and provide a mix ratio of high temperature fluid and low temperature fluid that results in a mixed fluid having a selected temperature flowing out of the third passage, wherein the valve body includes a first valve member associated with the first passage for regulating flow of high temperature fluid and a second valve member associated with the second passage for regulating flow of low temperature fluid,
wherein the first valve member is configured to allow only a limited flow of the high temperature fluid upon initial demand from the first passage, wherein the limited flow of the high temperature fluid is delivered to the thermostat element for heating the thermostat element to a selected setpoint temperature, wherein in a normal operating condition, upon reaching the setpoint temperature, the first and second valve members move to provide the mixing of the high and low temperature fluids.

24. A water heater comprising:
a body defining a chamber for holding water to be heated;
a heater for heating the water in the chamber to a threshold temperature;
an inlet opening and an outlet opening in communication with the chamber for flowing water therethrough;
an inlet line extending through the inlet opening and into the chamber for admitting relatively cold water into the chamber;
an outlet line extending through the outlet opening for permitting flow of relatively hot water from the chamber; and
a mixing valve including:
first and second inlet passages, an outlet passage, the first passage being in fluid communication with the inlet line, the second passage being in fluid communication with the outlet line, and the outlet passage being in selective fluid communication with the first and second passages, and
a valve assembly for mixing the relatively hot water with the relatively cold water to provide a flow of mixed water at a selected temperature through the third passage, the valve assembly including a thermostat element and a valve body actuatable by the thermostat element, the valve body including a first valve member for regulating flow of the relatively hot water and a second valve member for regulating flow of the relatively cold water, wherein the first valve member includes an orifice dimensioned to allow the limited flow of the relatively hot water upon initial demand from the first passage.

25. The water heater of claim 24 wherein the orifice is configured to limit flow of hot water during initial demand to a set flow rate under varying pressure drops.
